(19) United States
(12) Patent Application Publication
(10) Pub. No.: US 2017/0316191 A1
(43) Pub. Date: Nov. 2, 2017

(54) VISUAL MOTION CAPTCHA

(71) Applicant: NEW YORK UNIVERSITY, NEW YORK, NY (US)

(72) Inventors: Agota Sipos, Brooklyn, NY (US); Pascal Wallisch, Rutherford, NJ (US)

(21) Appl. No.: 15/582,552

(22) Filed: Apr. 28, 2017

Related U.S. Application Data
(60) Provisional application No. 62/329,700, filed on Apr. 29, 2016.

(51) Int. Cl. G06F 21/31; G09G 5/38; G09G 5/377

(52) U.S. Cl. CPC G06F 21/31; G09G 5/377; G09G 5/38; G06F 2221/2133; G09G 2340/12; G09G 2354/00; G09G 2340/0464

(57) ABSTRACT

A visual motion CAPTCHA.

### BACKGROUND OF THE INVENTION

Establishing a well-functioning CAPTCHA is a complex task that requires one's understanding of both the capabilities of current Artificial Intelligence (AI) software and the mechanisms and capabilities of human cognition. CAPTCHA stands for “Completely Automated Public Turing Test To Tell Computers and Humans Apart” and its main use case has been to make sure that automated programs cannot interact with programs that allow user input, or in other words, to protect online resources from abuse by automated agents (Ahn, Blum, & Langford, 2004). The Turing test was first proposed by Alan Turing in 1950 and was called “The Imitation Game” at the time (Turing, 1950). To Turing, it essentially proposed the question “Can machines think?” a question that is still hotly contested to this day (Copeland, 2015). The way that Turing believed that this question could be answered in the affirmative is if the machine could exhibit intelligent behavior indistinguishable from that of a human. Turing tested this premise by asking a participant to distinguish between two conversations: one that he or she was having with another human and one that he or she would have with a robot. If the human was not able to distinguish that they were speaking with a robot, the robot passed the Turing test.

Thus, for CAPTCHA, the goal is to ensure that a CAPTCHA cannot pass the Turing test. In some cases, the stakes are relatively low such as when preventing spam comments on a blog, but in other cases, such as setting up an online email account, this can be a very important tool for stopping identity theft and other nefarious activity (Ahn et al., 2007). The fundamental challenge involving the creation of useful CAPTCHAs is that the task that the user is asked to perform needs to be something that humans can do with relative ease but are hard for computers, or in other words computers must fail this Turing test, but humans must pass it.

Further, many current CAPTCHAs are specifically designed to feed information back into a learning algorithm. For example, some CAPTCHA schemes utilize identification of written words or numbers from an image (a photo, video still, or digitization of text). The human user's response to the CAPTCHA may be used to improve the underlying computer recognition algorithm, thus resulting in the need for increasing difficult (for a human user) CAPTCHA displays while the CAPTCHA becomes increasingly solvable by the computer.

However, this is a perpetual race. With the recent large advances in AI software and language recognition, making a CAPTCHA that is hard for a computer to pass is becoming increasingly intricate, and making it harder and harder for the user to actually be able to pass, i.e. to read or hear the letters easily (Goodfellow et al., 2014). There is also the problem of planned obsolescence in many of the existing CAPTCHAs that are widely used today, which will be reviewed in further detail later. There is a lot of frustration currently surrounding how difficult language recognition CAPTCHAs have become to users, which is why we feel that there is a real opportunity to make a different kind of CAPTCHA.

### SUMMARY OF THE INVENTION

The foregoing summary is illustrative only and is not intended to be in any way limiting. In addition to the illustrative aspects, embodiments, and features described above, further aspects, embodiments, and features will become apparent by reference to the following drawings and the detailed description.

One embodiment relates to a computer-implemented machine for generating a Completely Automated Public test to Tell Computers and Humans Apart (CAPTCHA). The machine includes a processor; and a tangible computer-readable medium operatively connected to the processor. The computer readable medium includes computer code configured to: select the number objects to display as background objects; select a type for the background objects; select a size for the visual display; select a number of frames for display; generate a first frame position for each of the background objects; generate a second frame position for each of the background objects, the second frame position generated by modifying the first frame position by a random value; create a target object for display on the visual display; generate a first frame position the target object; generate a second frame position for the target object, the second frame position generated by modifying the first frame position by a target object random value; display on the visual display the first frame and second frame in sequence; and receive an indication of the target dot first frame position.

Another embodiment relates to a method for generating a Completely Automated Public test to Tell Computers and Humans Apart (CAPTCHA). The method comprises: selecting the number objects to display as background objects; selecting a type for the background objects; selecting a size for the visual display; selecting a number of frames for display; generating a first frame position for each of the background objects; generating a second frame position for each of the background objects, the second frame position generated by modifying the first frame position by a random value; creating a target object for display on the visual display; generating a first frame position the target object; generating a second frame position for the target object, the second frame position generated by modifying the first frame position by a target object random value; displaying on the visual display the first frame and second frame in sequence; and receiving an indication of the target dot first frame position.

One embodiment relates to a system for generating a Completely Automated Public test to Tell Computers and Humans Apart (CAPTCHA). The system comprises a processor, a display, and a tangible computer-readable medium operatively connected to the processor. The computer readable medium includes instructions to receive a first frame having a first frame position for each of the background objects and a first frame position the target object; displaying the first frame on the display; receive a second frame position for each of the background objects the second frame position generated by modifying the first frame position by a random value and a second frame position for the target object; displaying on the display, following the first frame, the second frame in sequence; and receiving from a user input device, an indication of the target dot first frame position.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a prior art CAPTCHA scheme.

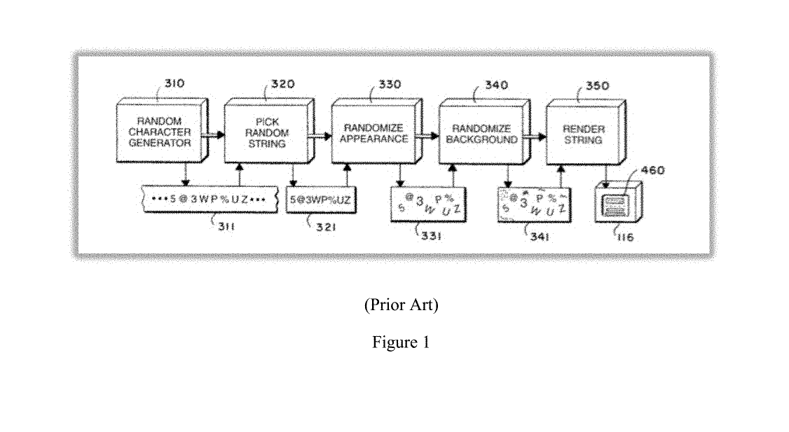

FIGS. 2A-2D illustrate different potential identification schemes that can be used with a CAPTCHA and their relative difficulty for both humans and computers. FIG. 2A involves prime factorization, which is hard for both humans and computers. FIG. 2B illustrates reverse alphabetical lookup, which is hard for humans but easy for computers. FIG. 2C illustrates a motion correspondence problem, which is easy for humans and hard for computers. FIG. 2D illustrates a number recognition scheme, which is easy for humans and easy for computers.

FIGS. 3A-3B illustrate random dot kinematograms (RDK's).

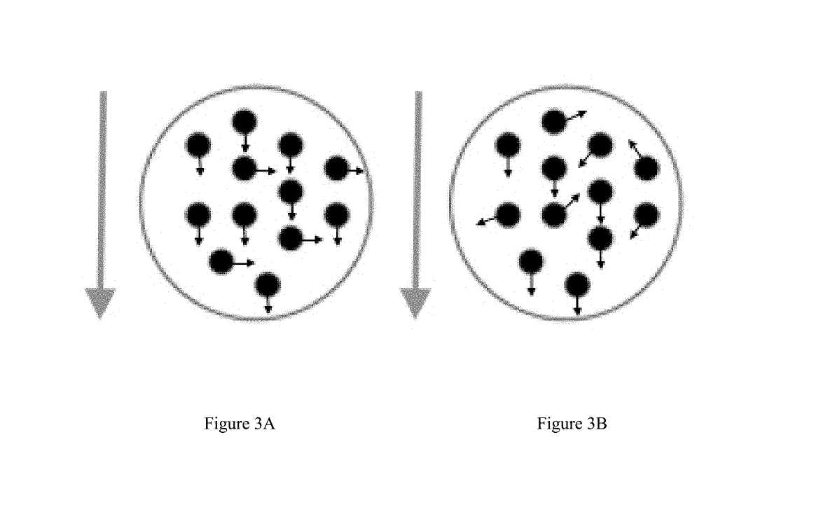

FIGS. 4A-4B illustrate an embodiment of a visualization of the CAPTCHA.

FIG. 5 illustrates a visual perception based CAPTCHA display populated with initial dots.

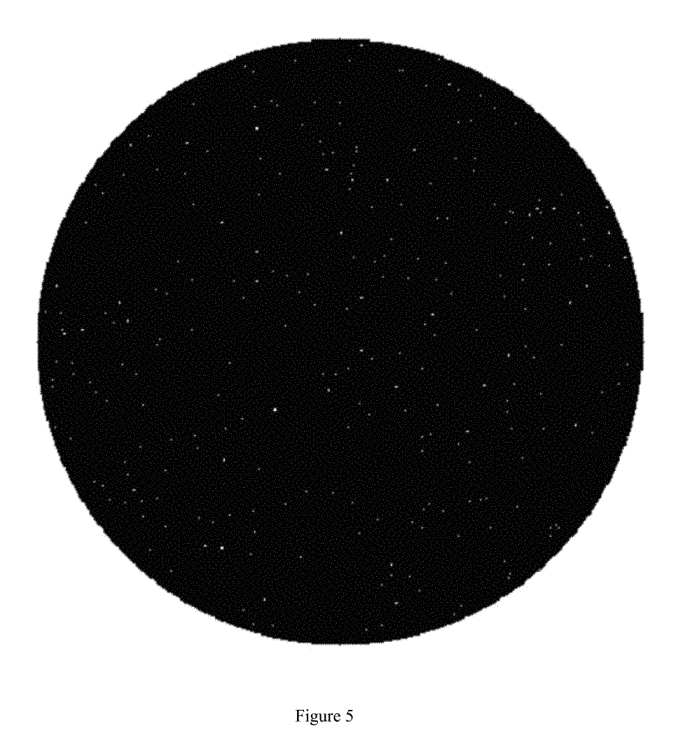

FIG. 6 illustrates a visual perception based CAPTCHA display. The horizontal and vertical lines indicate crosshair input from the user.

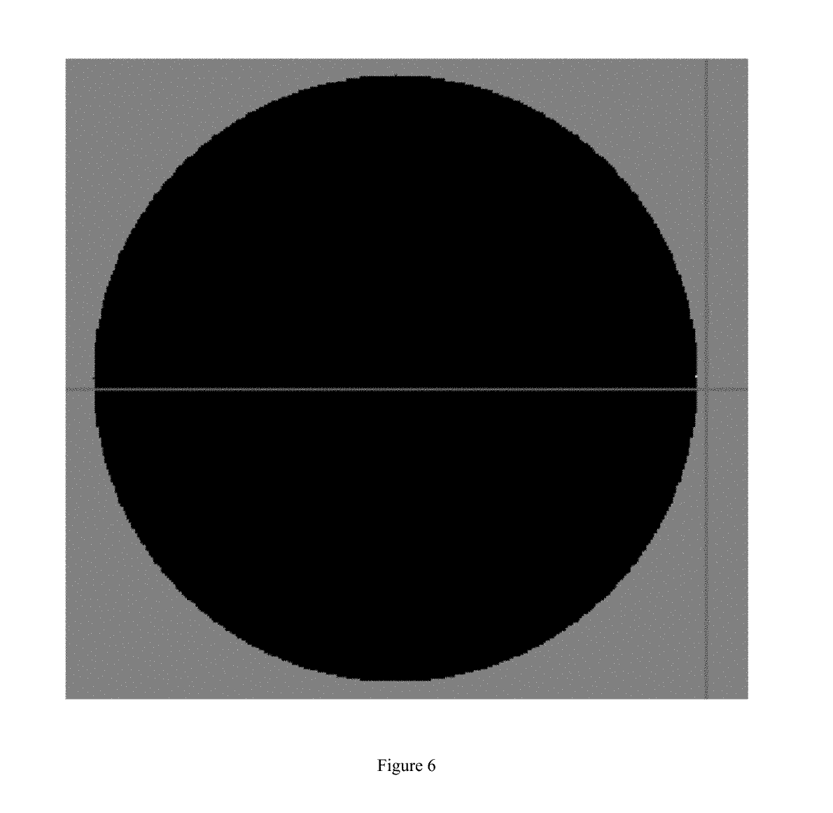

FIG. 7 illustrates a computer system for use with certain implementations.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

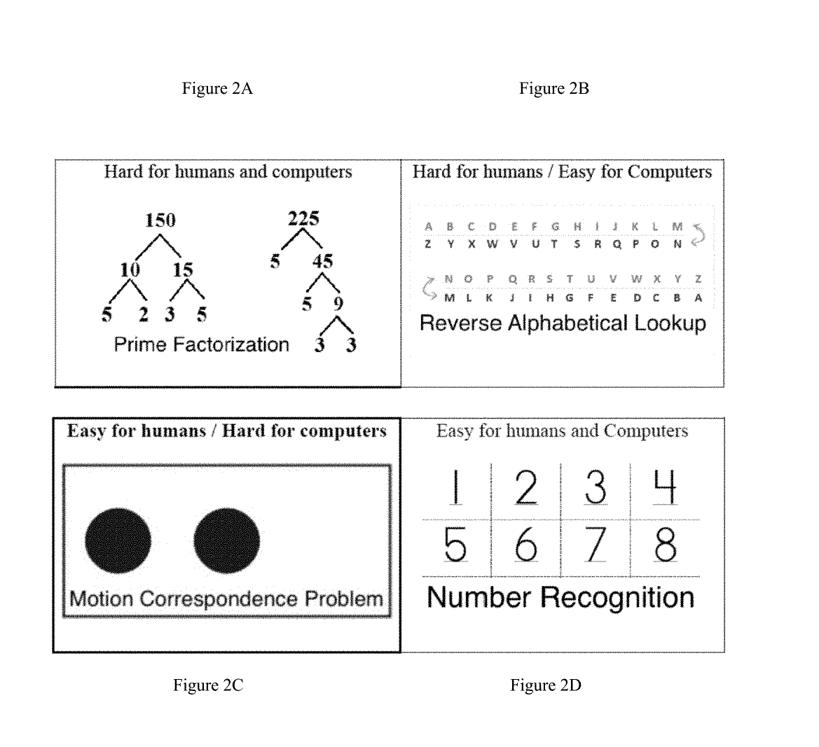

As described above, a CAPTCHA that is easy for humans and difficult for computers provides the most useful implementation. FIGS. 2A-D illustrate various tests and the relative difficulty for a human and a computer. While a CAPTCHA could utilize any of these as the test, those actions that are easy for computers will have poor accuracy in identifying computers from humans, while those that are difficult for humans and easy for computers will suffer the same problem as well as present the issue of frustrating a human user. One distinction between human capabilities and computer capabilities remains their relative skill at visual detection of motion. Thus, taking advantage of a test that is difficult for a computer and easy for a human provides for improved user experience and accuracy in identifying a computer respondent. One embodiment of the present invention relates to methods and systems for a visual motion CAPTCHA.

In one embodiment, the visual motion CAPTCHA focuses on an aspect of vision that one that is often overlooked or taken for granted. Human's (as well as many other animals) ability to perceive motion, easily and almost intrinsically, is something that is not often thought about but is nonetheless taken for granted. From an evolutionary standpoint, it is easy to see why motion detection must be a highly developed skill in humans and animals. An animal autonomously, first of all, is not stationary and must be able to detect its own motion before being concerned with anything else's motion (Borst, Egelhaaf 1989). This lays a solid foundation for motion detection of other beings. Motion detection has also been passed on, and in fact selected for, and therefore strengthened evolutionarily in cognition, because those organisms that are able to detect movement are usually safer from their predators. One of the main functions that the motion detection provides is to break camouflage, or be able to detect predators even if they are in their surroundings where they are well adapted to blend into (Nakayama & Loomis, 1974). Because of frequent occurrences where visual motion detection is imperative to survival, and the evolutionary advantage it presents, it makes sense that through natural selection, brain plasticity and the Hebbian theory (a theory that in its simplest terms, says “those cells that fire together, wire together”) (Arora et al., 2013), most animal brains, including humans', have become well practiced in visual motion detection.

One of the main areas in the brain that plays a pivotal role in motion detection is the striate cortex. After the retinal Ganglian cells of the brain encode information about the amount of light and wavelength of incoming light, the information is passed on to the striate cortex where it is processed additionally. Hubel and Wiesel (1959) found that specific neurons in the Striate Cortex actually corresponded with the orientation of different objects. They differentiated in between three different types of cells that perceived orientation by when they were excited or inhibited: simple cells, complex cells, and hypercomplex cells. It was observed that simple cells were those specific cells that were excited when an object (in this case a straight line) was in a certain position, but inhibited when that oriented line was not in the center of vision. Complex cells became excited as well when the bar was in a certain position, but did not necessarily inhibit if the bar was oriented in a different way. On the contrary, they would remain excited, especially in certain perpendicular orientations to the original orientation. The third category, hypercomplex cells, was also excited when the bar was in a certain orientation, but they actually inhibited at the end of the lines.

Another important discovery relating to hypercomplex cells and how those cells were responsible for picking up on lines and edges, was the work done by De Valois, Albrecht and Thorell on spatial frequency and sine wave gratings (1978). This research showed participants a square wave grating with bars in different with varying brightness laid out vertically and unfocused. What was found was that neurons in the striate cortex responded best when a sine wave grating of a particular spatial frequency is placed in the corresponding part of the visual field. As it was for the bar orientations, different neurons responded to different spatial frequencies. Pivotal to both the spatial frequency and the orientation and movement cells is that the visual cortex actually combines information from several sources to detect features of vision that are larger than any one receptive field of a cell (Hubel & Wiesel, 1979). This makes it understandable in motion correspondence that not only is the object appearance taken into consideration, but also the orientation, the movement and the features of the object.

Pivotal to motion processing in humans is the V5/MT (middle temporal gyrus) part of the brain. It is supposed that the MT part of the brain is very important in detecting and understanding motion, and is somewhat of a next layer of processing after the V1 layer. This layer was found by two different groups of researchers at the same time, Dubner and Zeki in 1971 after noting them in rhesus monkeys and Allman and Kass in 1971 after finding the same thing in owl monkeys. The MT is layer is essentially an extrastriate layer that is fairly close to the retina (Born & Bradley, 2005). There are very high amounts of myelination density in this area, leading some to call it the densely myelinated zone (Lewis & van Essen, 2000). Similarly to the V1 areas, it was shown that the MT contained a high concentration of direction selective neurons in monkeys, but unlike V1 receptors, they were not sensitive to the actual form of the stimulus. It has been shown that the MT area's strongest connections are to the V1 and V2 area, and in particular the 4B layer of the V1 area (Shipp & Zeki, 1989). MT, however, is retinotopically organized, meaning that it is mapped according to the visual system, and mainly emphasizes the fovea, meaning that there is a concentration in the center of the visual field that occupies much of the MT's surface area (Huk, Dougherty & Heeger 2002).

There have been many studies carried out in order to differentiate what the MT area does that the V1 area does not, as they seem to have many things in common, such as having neurons that respond to specific motions, as described above. It was originally believed that perhaps MT specialized in long range processing; meaning that its visual field was larger than that of the V1 area. However, it was later found that MT actually had more characteristics of a short-range perceptual process, such as how neuronal interaction takes place in small spatial ranges (Livingstone & Conway, 2003). It is now believed that one of the main functions of the MT that is not inherited from the V1 area is that of computing velocity, or computing the motion of whole objects and patterns (Orban et al, 1986). Through presenting different variations of the aperture problem, researchers believe that the MT could have two functions that differentiate it from the V1.

The aperture problem is that when a one-dimensional object is moving through an aperture that conceals or obstructs the ends of the object, it is not possible to actually determine the motion of the object. This is important in visual motion processing as it relates to being able to detect motion accurately. In primates, visual motion is first computed in the V1 area, as mentioned above, but these neurons have very small receptive fields. Researchers believe that this information is passed on to the MT area to make a 2D model out of the different 1D samples (Pack, Gartland & Born 2004). How this is done is being debated. One school of thought is that the V1 system handles all of the linear computations that are needed while the nonlinear computation happens in the MT. This would require an intersection of constraints model of construction from the information given by the V1 to the MT, which uses local motions of two edge pieces of a figure to find the global motion (Adelson, Movshon 1982). The physiological method in which this works can be explained by a model proposed by Movshon et al., simply stating that a front end is made of linear V1 cells whose outputs are summed over a plane in frequency space by an MT pattern cell (1985). Perhaps an even more important computational model of the physiological properties of MT is one set forth by Simoncelli and Heeger (1998). This computational model accounts for MT physiology, where local image velocities are represented via a distribution of MT neuronal responses. Another theory of MT's role in determining velocity is that the V1 phase is responsible for both linear and non-linear movement calculation but the MT acts to collect all of this information. Most likely, these two theories are both applicable, but one is more relevant than the other when determining certain types of motion (van Hateren, 1992).

The visual motion CAPTCHA does not take advantage only of human visual strengths, but also computer motion detection weaknesses. Building a CAPTCHA that takes most human impairments into account and still cannot be solved by computers however can absolutely be done. One of the most basic features of human cognition and perception, visual motion detection, is still extremely difficult for computers to do. There have been algorithms that have been able to effectively detect motion, however, they have only been able to detect motion when all else is stable by comparing frames of film to previous frames and determining what had changed, a technique called background subtraction (Figueroa, Leite & Barros, 2013). Humans, and most animals, however, are able to detect motion with an astonishing amount of accuracy (Scase et al. 1996). It has been found through Random Dot Kinematograms that even with a lot of motion “noise” travelling around, as long as there is a coherence level of motion of only around 3-5%, it will be enough for a human to detect quite easily (Watamaniuk & Sekuler 1992). This is without any of the points having any type of distinguishable features from another. If humans are shown the same form multiple times, this percentage can be even lower (Scase, Braddick, & Raymond 1994).

It is not exactly known how the human brain solves what is called the motion correspondence problem, the problem that the any visual system whether human or machine, would have to infer motion from one frame to another by tracking elements identity from frame to frame (Ullman, 1979). There are many different theories that psychologists have proposed, most of which involve feature information and spatio-temporal information as the two most important factors in gathering accurate motion correspondence information (Heine & Moore, 2012). Feature information correspond to features of the object that is moving around that stay the same no matter what. A simple example of this is that a person who is moving around keeps the same facial features no matter what, meaning that there is a good amount of certainty that the person who is on one side of the room one minute and the other side of the room at the next minute is the same person. There is also the spatio-temporal aspect, which looks at proximity of stimuli in space and time. The simplest example of this again is thinking about your friend moving in a room. If the person is on one side of the room in one minute and another side 5 minutes later, you can assume it is the same person from their features and previous knowledge of how long it typically takes someone to walk from one place to another. However, if in a blink of an eye your friend is suddenly on the other side of the room, you can assume that perhaps it is a different person or your friend has figured out teleportation. There is also a good amount of evidence to support that establishing motion correspondence does not only rely on image based features but also scene based features, such as the size of surfaces, or the illumination conditions (Hein & Moore, 2014). Most likely, it is a combination of all three of these things that contribute to good motion correspondence in human beings.

In contrast, computers are notoriously bad at perceiving the direction of moving objects, which is mostly owed to the motion correspondence problem. The motion correspondence problem results from the fact that a computer analyzes motion by comparing an image frame-by-frame. When there are n number of elements (such as dots) in two consecutive frames, then there are n! possible solutions to the motion correspondence problem, which makes it almost intractable to figure out which dot is which and how it moved where unless there are very few picture elements involved.

There are heuristics to make this problem more tractable. For instance, one could assume that the dot closest to the position of the dot in the previous frame is the dot most likely to be the same dot (nearest neighbor constraint). One could also assume that motion will be smooth and a given dot will move with a particular velocity (velocity constraint). Finally, the assumption of element integrity—that picture elements don't change shape or number—helps to resolve the fundamental ambiguity of displays with moving elements. However, it is important to note that heuristics can help a machine to resolve this problem, but that this is a process that is far from perfect, particularly if there are many dots involved (thus rendering the nearest neighbor heuristic less useful), if they are allowed to change velocity (rendering the velocity constraint impotent) and if the number of elements can change and if they have an amorphous shape, like in dots that are all the same color.

Current motion correspondence algorithms try to solve the motion correspondence problem in two different ways: Deterministic and Statistical (Firouzi & Najjaran, 2012). One way of determining motion correspondence is using a deterministic algorithm. What this algorithm essentially will do is make a cost function of spatio-temporal information. This means that it will try to mimic the same spatiotemporal analysis that humans can do by taking the dots and reducing the possible trajectories by setting parameters of the maximum or minimum amount of movement that each object would make. Another type of algorithm is the statistical model, which tries to estimate the object state, meaning the position and velocity by taking uncertainties into account. It mainly does this with statistical data association methods, such as the Probabilistic Data Association Filter (Rasmussen & Hager, 2001) and Multiple Hypothesis Tracking (Hue, Cadre & Prez, 2002). These essentially ensure that weak connections are not made in between dots by using a confidence interval and do not necessarily connect two dots when there is not enough certainty in two frames. It can essentially wait until the next frame to ensure that there is a fair amount of certainty, based on velocity and amount of movement that it is linking the correct dot with the correct movement.

However, these efforts are insufficient to be comparable to human's talents in visual motion perception. In particular, the solution to the motion correspondence problem above solves the motion correspondence only when there are several dots moving on a more or less straight trajectory or angle. This algorithm also had a very small error rate only when there are 60 or less objects and only about 20 frames (Firouzi & Najjaran, 2012). Humans can do this with almost no constraints in this respect or initial processing time.

In one embodiment, systems and methods are provided for a visual motion perception CAPTCHA. A visual motion perception CAPTCHA utilizes the feature of the human's ability to detect motion correspondence very easily and the computer's difficulty with the same task.

In one embodiment, the visual motion perception CAPTCHA is implemented in MATLAB, a 4^{th} generation programming language optimized for linear algebra and data visualization. While MATLAB was used in the examples herein because of its quick plotting and imaging functions and general ease in setting up a Graphical User Interface (GUI), other suitable program languages and GUI setups may be used. Another benefit in the use of MATLAB is the ability to set up all of the information easily in a series of matrices, which also allowed quicker computing times, and therefore a smoother display.

The visual motion perception CAPTCHA provides one or more objects on a visual display. One method of providing a visual motion perception CAPTCHA requires the definition of several variables: 1) the type and diversity of the objects (dots in the examples herein), 2) number of objects in the display (500 in the examples herein), 3) the size of the matrix displayed on the visual display (400×400 in the examples herein), 4) the number of frames displayed, as well as the speed of cycling of the frames and other parameters relating to their display.

As noted, the examples herein use dots as the objects. Alternative embodiments may use different shapes, including more than one shape and/or randomly selecting shapes for use. For example, embodiments may utilize a plurality of shapes with a target object being one of the plurality of shapes. Further, the objects may be colored and the CAPTCHA includes audio or written instructions as to the color of the target object. The number of objects, such as dots, provides the background objects, i.e. the “noise” to obfuscate from the computer the target object's movement. In the examples, the number of dots has been set at 500. It should be appreciated that increasing this number increases the difficulty for both humans and computers, but because of the differences in how each processes visual image, computers may be forced to contend with vastly more complicated analysis. For 500 dots, there are 500! combinations, when attempting to compute the motion correspondence problem becomes more than 1.2×10¹¹³⁵ in each frame-by-frame comparison. The size of the matrix is also determined by these variables, and can be set to meet the needs of the implementers. Examples herein use a 400×400 matrix, meaning that the 500 dots will be plotted on an axis of 400 by 400 for a dot density of 1 dot per 320 pixels, or less than 0.3%.

As noted, how the frames are displayed can also be varied. The number of frames will reflect in two different ways—the duration of the CAPTCHA image that will be displayed, and the number of frame comparisons that a computer would have to make in order for it attempt to solve the motion correspondence problem. It is set in the examples at 500, making the computation needing to be done in order to solve the problem (1.2×10¹¹³⁵)×500!. This is obviously a very large computational problem, something currently considered intractable, meaning that it would require much too long to solve in the worst case.

Next, with those variables selected, in one embodiment an initial Matrix (M1) is defined, containing only zeros. This initial Matrix is set so that there is memory is allocated for the size of the matrix, making sure that as the matrix is built, there is no need for continually making a new matrix each time a value is added, and speeding up the processing time of the program. It is defined as a uint8 matrix in order to utilize the properties of an image matrix in MATLAB, where a matrix is converted to a matrix of unsigned 8 bit integers, allowing each point in the matrix to represent up to 255 outcomes, which is what is needed to represent the entire color spectrum. In the examples provided herein, the area within the aperture is black with the dots being white circles and the background behind the aperture being white. It should be appreciated that various color combinations could be used to improve contrast for humans and/or decrease the ease of machine recognition. This initial matrix is created to allocate a designated amount of memory and acts as a container for all of the plot properties. Next, a temp, a 500×2 matrix is defined that will be used to define the initial points of the matrix and be updated in each frame. The initial dots are defined by simply using the rand function in MATLAB. This function gives a uniformly distributed random number by default in the interval of 0-1. We make sure to receive numbers from 1 to 500 in the temp matrix.

In one embodiment, the plotting is on a standard x by y-axis graph, meaning that the dots move throughout a rectangular space. In a further embodiment, the visual perception based CAPTCHA could be implemented in a 3-d environment. For example, the plotting could be an x-y-z three axis graph and the aperture, described below, represented by a three dimensional shape such as a sphere. Like-wise the objects could be three dimensional shapes, including more complicated shapes or utilizing shapes-within-shapes based on transparent outer surfaces .

Furthermore, in one implementation, the visual display has an aperture represented a defined area within the visual display. The aperture may have a color that contrasts with the objects. In one embodiment, the visual motion based CAPTCHA is designed for a user to identify motion of the object within the aperture. In one particular embodiment, the goal of the visual motion based CAPTCHA, that is the “key” to passing the test, is to identify where the target object crosses the perimeter of the aperture. Whiel the aperture is shown as a circle in the present Figures, the aperture's can take various shapes. In one embodiment, the aperture's size is determined by the maximum radius of the matrix. By having the aperture be smaller and subscribed within the boundaries of the matrix, the visual motion based CAPTCHA will have dots move outside of or beyond the aperture while still within the matrix (or prior to wrapping around for implementations utilizing the feature). This makes sure that the random dots do not have lasting integrity, and makes the computational problem harder, as there will never be a one to one match in frame comparisons. The integrity of the dots is something that will make the computational effort of any algorithm even more difficult, as the computer has no way to even count the amount of dots that is dealing with. For example, one frame may have 482 dots, and the next one may have only 460, simply because some dots may have moved randomly out of aperture. This does not make the motion correspondence problem more difficult in humans however.

In one embodiment, the aperture is drawn by simply defining a radius by cutting our initial matrixSize in half. Then, in a loop we check for the points that will be outside of the radius. When the point is outside of the radius it may be set to a specific color, such as white or grey, or not shown. Thus, the objects that are positioned on the matrix but outside of the aperture exist, but are not visible on the display. In one embodiment, the objects falling in this region are not displayed, in another embodiment, the objects color is the same as the backround, thus when not positioned on the contrasting aperture, the objects can not be discerned. In one embodiment utilizing a wrapping feature, when an object would leave the matrix, i.e. the x-y grid, the object wraps around, so if the object reaches the maximum y-axis (or x-axis) (whatever this is set to) it will wrap around back to some value on the matrix, such as y=1 (or x=1). This avoids edge artifacts and aliasing.

Next, the initial dots are made on the plot and the movement of the random noise is made. In one embodiment, initially the dots are graphed one by one by going through the number of dots and plotting them from temp. Then, we have to define the next motion of the dots randomly. For this we create another matrix motMat, also a 500×2 matrix that consists solely of 1, 0, and −1. Next we define the final matrix that will contain all the information that is needed for the movement of the random motion, called allFrames and set all of its initial values to 0. Then we make the entire CAPTCHA, going in a loop through each frame and adding motMat to temp, changing the position of the every random dot by 1 randomly chosen direction (1, 0, −1). In one embodiment, while doing this we go through every dot to ensure that the dot is within the plot boundaries, and if it is outside of the boundaries we create a wrap around, meaning that if the dot has gone too far in either direction it will reappear in the opposite direction. This is just to ensure that the program does not crash, but also gives a sense of continuity of all dots on the graph, not on the aperture. Every frame is then put into the allFrames matrix.

Having created the random object noise, we need to add a specified target object. In one embodiment, the creation of the random objects and the target object can be in any order. Further, in one embodiment each frame is fully generated before being displayed. Thus, when the frame is displayed both the random noise objects and the target object are displayed, along with the aperture. Further, all frames to be displayed may be created prior to display of any frame. In one embodiment, 500 frames are displayed in rapid succession The random dot noise does not necessarily need to be created first. As of right now, the program generates all frames of the image before the image is displayed, whether the target dot is made first or the random noise does not matter, as it will be done before the image is displayed. The overlap, as of right now, is not prevented, but should not be a major impeding factor in human detection (as there are 500 frames, if for one frame two dots overlap it will not interfere with trajectory detection). In one embodiment, the target object is generated by at the center point of the matrix white, picking a random direction for it to go in, and going in that random direction in subsequent frames until it reaches the end of the matrix. Alternative embodiments can be made more complicated in order for it to maintain its security integrity. Further embodiments provide for more complicated pathing of the target object by picking a random end point of the aperture, adding curvature to the target object's trajectory.

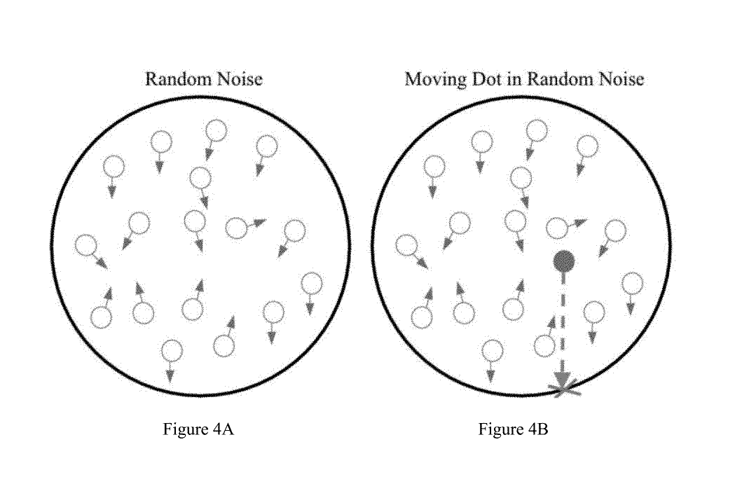

FIGS. 4A-B illustrate one embodiment. In FIG. 4A, the random movement of the background objects is shown. In FIG. 4B, the movement of the target object along a vector (as opposed to random motion) is illustrated, as well as indicating the path of motion that would be illustrated in subsequent frames with an eventual exit of the target object from the circle corresponding to the visual aperture. For this, we also simply use another loop that will go for the length of the frames. The variable dot is created which initially is simply the radius value in order for the dot to start in the middle. Again, this can be randomized later, but for now doesn't need to be, and makes it as easy as possible for the user. There is a direction that is chosen randomly (again in the same way that motMat was created, with a −1, 0, and 1 chosen randomly for each variable) and is added to dot until the end of the frame time. The old dot is then erased and a new dot is plotted. If it reaches the end of the plot, it simply stays in the same position for the remaining duration of the image. The number of frames may be selected based on the number of frame in which the target object is still “moving”, i.e. until it exits the aperture or until it reaches the edge of the matrix, for example.

After this is the time when a user is asked to indicate with the mouse (trackpad, touchscreen, or whatever means of input that the user has) where the dot on the specified trajectory left the circle. We added the ginput function in MATLAB (or the appropriate similar function in the chosen programming language), allowing the user to make a selection on the plot and have the inputs returned as x and y coordinates. It is important that the inputs are returned, as we will later use them in a comparison of where the dot left the point. If the dot is within a predetermined distance, in the chosen example 10 points, of the actual point where the trajectory dot left the circular aperture, we consider it a “hit” and the user is allowed to pass through this security measure. If not, then this test can be done again or another CAPTCHA test.

1. Results

Our expected results indicate that our visual motion CAPTCHA will be effective and efficient. We believe that this will become the crux of the CAPTCHA, that not only will it fill a gap that is needed for security purposes and other CAPTCHAs slowly becoming obsolete, but that it is far easier and much less time consuming than other CAPTCHAs. From an informal testing, every human user was able to complete the CAPTHA within seconds after the target dot left the circle and the image was done. This is essential, as it shows how little cognition is required and the intuitiveness of the visual motion CAPTCHA. We strongly believe that another benefit of this visual motion CAPTCHA is that this high level of performance is not likely to drop in any one population. That is, the visual motion CAPTCHA is language and knowledge independent. There are many factors that contribute to performance in a language based CAPTCHA, but our visual motion CAPTCHA relies solely on something that is intrinsically in every human being. It does not rely on any learned skills, such as mastering the English language, or in fact any literacy whatsoever. The fact that visual motion detection is something that is so hard to compromise will only add to its success: we can rely on the fact that even neurologically or visually impaired individuals will be able to solve this visual motion CAPTCHA with ease. This can make all the difference in accessibility and convenience for all involved.

Again, we do expect that computers will have a lot of difficulty in solving this CAPTCHA, at least in a reasonable amount of time, due to the motion correspondence problem above. Even if the computing power was available for the amount of possibilities, the computer will inevitably be tripped up by some of the problems that the visual motion CAPTCHA presents, such as lack of object integrity which compromises spatio-temporal information, and a large set of homogenous items which compromises the usefulness of any feature information, or any features that may be of use to distinguish a target dot from random noise. However, in additional embodiments of the visual motion CAPTCHA, layers of complexity can be added. For example, we can add a curve to the trajectory of the target dot, or have select gradients of the random noise have motion correspondence through gradients, which would further complicate any algorithm that could potentially solve this. This would presumably not add much trouble to the human user, but is relatively unexplored in visual motion perception literature. This visual motion CAPTCHA could also potentially be used to test the limits of visual motion perception in humans by adding these difficulty factors in solving it.

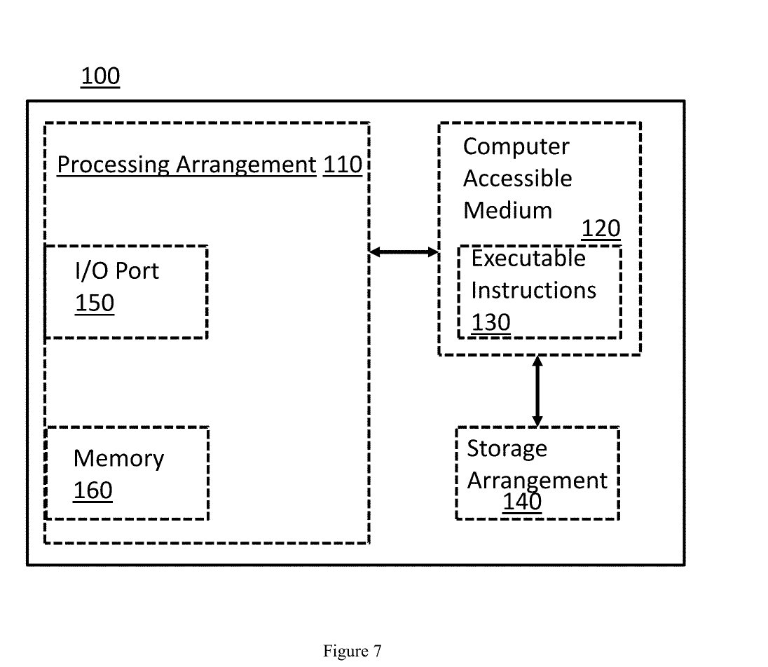

As shown in FIG. 7, e.g., a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 100 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. Therefore, the above embodiments should not be taken as limiting the scope of the invention.

What is claimed:

1. A computer-implemented machine for generating a Completely Automated Public test to Tell Computers and Humans Apart (CAPTCHA) comprising:
a processor; and
a tangible computer-readable medium operatively connected to the processor and including computer code configured to:
select a type for a plurality of background objects;
select a number of background objects to include in the plurality of background objects;
select a size for the visual display;
select a number of frames to display;
generate a boundary for display;
generate a first frame position for each of the background objects;
generate a second frame position for each of the background objects, the second frame position generated by modifying the first frame position by a random value;
create a target object for display on the visual display;
generate a first frame position of the target object;
generate a second frame position for the target object, the second frame position generated by modifying the first frame position by a target object random value, moving the target object towards the boundary;
display on the visual display the boundary and the first frame and second frame in sequence; and
receive an indication of the target object position.

2. The computer implemented machine of claim 1, wherein the random number is selected from the set consisting of 1, 0, and −1.

3. The computer implemented machine of claim 1, wherein the tangible computer-readable medium operatively connected to the processor further includes computer code configured to generate a matrix with the number of objects each having a unique position in the matrix;

4. The computer implemented machine of claim 1, wherein the tangible computer-readable medium operatively connected to the processor further includes computer code wherein the indication of the target object position corresponds to an indication of where on the boundary the target object crossed the boundary.

5. The computer implemented machine of claim 1, wherein the plurality of background objects and the target object have the same type.

6. The computer implemented machine of claim 1, wherein the plurality of background objects and the target object have the same shape.

7. The computer implemented machine of claim 1, wherein the plurality of background objects and the target object have the same type.

8. A method for generating a Completely Automated Public test to Tell Computers and Humans Apart (CAPTCHA) comprising:
selecting the number objects to display as background objects;
selecting a type for the background objects;
selecting a size for the visual display;
selecting a number of frames for display;
generating a first frame position for each of the background objects;
generating a second frame position for each of the background objects, the second frame position generated by modifying the first frame position by a random value;
creating a target object for display on the visual display;
generating a first frame position the target object;
generating a second frame position for the target object, the second frame position generated by modifying the first frame position by a target object random value;
displaying on the visual display the first frame and second frame in sequence; and
receiving an indication of the target dot second frame position.

9. The method of claim 8, wherein the random number is selected from the set consisting of 1, 0, and −1.

10. The method of claim 8, wherein the tangible computer-readable medium operatively connected to the processor further includes computer code configured to generate a matrix with the number of objects each having a unique position in the matrix;

11. The method of claim 8, wherein the tangible computer-readable medium operatively connected to the processor further includes computer code wherein the indication of the target object position corresponds to an indication of where on the boundary the target object crossed the boundary.

12. The method of claim 8, wherein the plurality of background objects and the target object have the same type.

13. The method of claim 8 The method of claim 8, wherein the plurality of background objects and the target object have the same shape.

14. The method of claim 8, wherein the plurality of background objects and the target object have the same type.

15. A system for generating a Completely Automated Public test to Tell Computers and Humans Apart (CAPTCHA) comprising:
a processor;
a display;
a tangible computer-readable medium operatively connected to the processor and including computer code configured to:
receive a first frame having a first frame position for each of the background objects and a first frame position the target object and a boundary;
displaying the first frame on the display;
receive a second frame position for each of the background objects the second frame position generated by modifying the first frame position by a random value and a second frame position for the target object and the boundary;
displaying on the display, following the first frame, the second frame in sequence; and
receiving from a user input device, an indication of a point where the target dot crosses the boundary.

16. The system of claim 15, wherein the random number is selected from the set consisting of 1, 0, and −1.

17. The system of claim 15, wherein the tangible computer-readable medium operatively connected to the processor further includes computer code configured to generate a matrix with the number of objects each having a unique position in the matrix;

18. The system of claim 15, wherein the tangible computer-readable medium operatively connected to the processor further includes computer code wherein the indication of the target object position corresponds to an indication of where on the boundary the target object crossed the boundary.

19. The system of claim 15, wherein the plurality of background objects and the target object have the same type.

20. The system of claim 15, wherein the plurality of background objects and the target object have the same shape.
